(19) United States
(12) Patent Application Publication
(10) Pub. No.: US 2008/0042933 A1
(43) Pub. Date: Feb. 21, 2008

(54) Plasma display panel

(76) Inventors: Hyea-Weon Shin, Suwon-si (KR); Jeong-Nam Kim, Suwon-si (KR); Myoung-Sup Kim, Suwon-si (KR); Young-Do Choi, Suwon-si (KR); Tae-Jung Chang, Suwon-si (KR); Tae-Seung Cho, Suwon-si (KR); Won-Seok Yoon, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/893,387

(22) Filed: Aug. 15, 2007

(30) Foreign Application Priority Data
Aug. 21, 2006 (KR) 10-2006-0078878

(51) Int. Cl. G09G 3/28

(52) U.S. Cl. 345/66

(57) ABSTRACT

A plasma display panel capable of improving stability of discharge. The plasma display panel includes a first substrate, a second substrate facing the first substrate, discharge cells defined in a space between the first substrate and the second substrate, first electrodes formed between the first substrate and the second substrate and extending along a first direction, and second electrodes formed apart from the first electrodes on the second substrate and extending along a second direction perpendicular to the first direction. The second electrodes protrude from the second substrate, and third electrodes are formed apart from the first electrodes on the second substrate and extend along the second direction, wherein the third electrodes protrude from the second substrate and face the second electrodes. A dielectric layer is formed on the outer surface of the second electrodes and the third electrodes, wherein the dielectric layer includes a first dielectric member formed on the surfaces of the second electrodes and the third electrodes facing each other, and a second dielectric member formed on the first dielectric member and having smaller permittivity than that of the first dielectric member.

### CROSS-REFERENCE TO RELATED APPLICATION

This application claims priority to and the benefit of Korean Patent Application No. 10-2006-0078878 filed in the Korean Intellectual Property Office on Aug. 21, 2006, the entire content of which is incorporated herein by reference.

### BACKGROUND OF THE INVENTION

1. Field of the Invention

The present embodiments relate to a plasma display panel, and more particularly, to a plasma display panel that includes a dielectric layer structure that improves stability of discharge.

2. Description of the Related Art

Plasma display panels (PDPs) display an image by using visible light generated when vacuum ultraviolet rays radiating from plasma generated by a gas discharge excite a phosphor material. The PDPs enable extra-large size screens of larger than 60 inches to be thinner than 10 cm. In addition, the PDPs have excellent capacity for reproducing colors and no distortion according to viewing angle. The PDPs have advantages of greater productivity and lower cost due to a simpler method of manufacturing than LCDs, and are spotlighted as the next generation industrial flat panel display and home TV display.

The structure of the PDP has been developed for many years, since the 1970s, and the generally-known structure now is a three-electrode surface discharge PDP. The three-electrode surface discharge PDP includes one substrate that includes two electrodes arranged on the same surface, and another substrate that is arranged at a certain distance therefrom and includes address electrodes extending in a perpendicular direction. A discharge gas is filled in the space between the pair of substrates and the substrates are sealed against each other.

Generally, whether or not the discharge occurs is determined by the discharge of scan electrodes that are connected to each line and independently controlled, and address electrodes facing the scan electrodes. In addition, sustain discharge that displays brightness is generated by two electrode groups, namely sustain electrodes and scan electrodes, that are located on the same surface.

However, the three-electrode surface discharge PDPs have a difficulty in displaying high-resolution images. In other words, consumers currently tend to demand high-resolution PDPs so that the size of the sustain electrodes and the scan electrodes that are located on the same surface in the three-electrode surface discharge PDPs needs to become smaller, which may cause problems such as a decrease of brightness and efficiency together with an increase of the discharge firing voltage. Therefore, as the resolution of the PDPs increases, PDPs with different structures from the three-electrode surface discharge PDPs need to be developed.

### SUMMARY OF THE INVENTION

The present embodiments provide a plasma display panel capable of having a discharge between sustain electrodes and scan electrodes lead to an opposed discharge between sustain electrodes and scan electrodes.

The present embodiments also provide a plasma display panel capable of stabilizing the opposed discharge between sustain electrodes and scan electrodes by forming a multi-layered dielectric layer having different permittivities on the outer surfaces of sustain electrodes and scan electrodes, and of enabling opposed discharge from the beginning of discharge.

According to one aspect of the present embodiments, a plasma display panel is provided, having a first substrate, a second substrate facing the first substrate, discharge cells defined in a space between the first substrate and the second substrate, first electrodes formed between the first substrate and the second substrate and extending along a first direction, and second electrodes formed apart from the first electrodes on the second substrate and extending along a second direction perpendicular to the first direction. The second electrodes protrude from the second substrate and third electrodes are formed apart from the first electrodes on the second substrate and extending along the second direction. The third electrodes protrude from the second substrate and face the second electrodes, and a dielectric layer is formed on the outer surface of the second electrodes and the third electrodes, wherein the dielectric layer includes a first dielectric member formed on the surfaces of the second electrodes and the third electrodes facing each other, and a second dielectric member formed on the first dielectric member and having permittivity that is smaller than the permittivity of the first dielectric member.

The plasma display panel may include barrier ribs partitioning the discharge cells and formed adjacent to the first substrate, wherein the barrier ribs include first barrier rib members extending along the first direction and second barrier rib members extending along the second direction.

The first electrodes may be formed on the second substrate and located on the boundary of the discharge cells adjacent to each other along the second direction.

The first electrodes may include transparent electrodes protruding into the center of respective discharge cells, and the transparent electrodes are formed closer to the third electrodes than the second electrodes.

The second electrodes and the third electrodes may be located on the boundary of the discharge cells adjacent to each other along the first direction, and arranged alternately along the first direction.

The second dielectric member may be formed on the surfaces of the second electrodes and the third electrodes facing each other, and a width of the second dielectric member measured along the first direction may be smaller than a width of the first dielectric member.

The second dielectric member may be located closer to the surfaces of the second electrodes or the third electrodes facing the first substrate than the first dielectric member.

The plasma display panel may include a third dielectric member covering the surfaces of the second electrodes and the third electrodes facing the first substrate, and formed on the second dielectric member.

A length of the second dielectric member measured along a direction perpendicular to the second substrate may be smaller than a length of the first dielectric member.

According to another aspect of the present embodiments, a plasma display panel is provided, having a first dielectric member formed on the surfaces of the second electrodes and the third electrodes facing each other, and a fourth dielectric member covering the surfaces of the second electrodes or the third electrodes facing the first substrate and having permittivity smaller than permittivity of the first dielectric member.

The width of the fourth dielectric member measured along a direction perpendicular to the second substrate may become smaller along a direction from the center of surfaces of the second electrodes or the third electrodes facing the first substrate to edges thereof.

The first dielectric member includes a plurality of stacked dielectric members having different permittivities, and the plurality of dielectric members are stacked in descending order of permittivity along a direction away from the second substrate.

### BRIEF DESCRIPTION OF THE DRAWINGS

FIG. 1 is a partial perspective exploded view showing a plasma display panel according to a first embodiment.

FIG. 2 is a partial plan view schematically showing structures of electrodes and discharge cells of a plasma display panel according to a first embodiment.

FIG. 3 is a cross-sectional view showing the display panel assembled and taken along line III-III of FIG. 1.

FIG. 4A to FIG. 4D show a process of sequentially forming dielectric layers on the outer surfaces of the electrodes of a plasma display panel according to a first embodiment.

FIG. 5 is a partial cross-sectional view showing a plasma display panel according to a second embodiment.

### DETAILED DESCRIPTION OF THE EMBODIMENTS

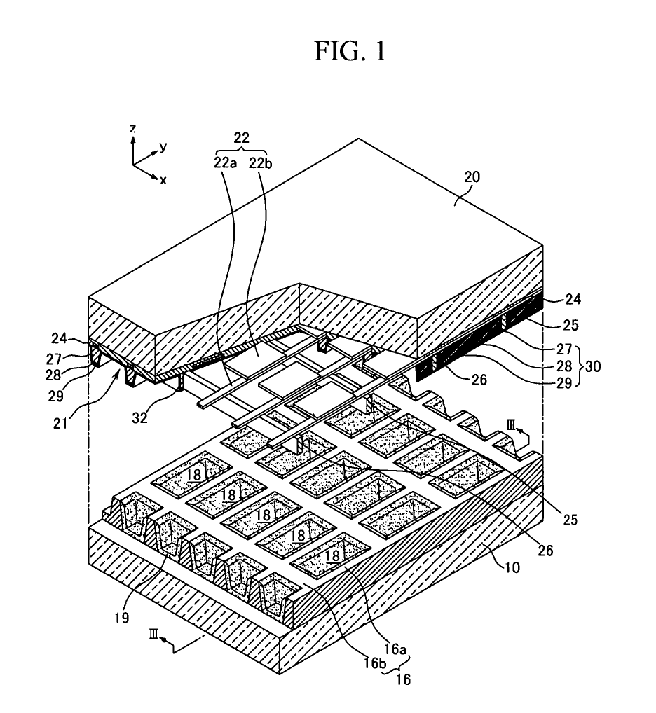

Referring to FIG. 1, the plasma display panel (PDP) of the first embodiment includes a first substrate (hereinafter referred to as a rear substrate) and a second substrate (hereinafter referred to as a front substrate) facing each other with a certain distance therebetween. A plurality of discharge spaces 18 and 21 are partitioned between the rear substrate 10 and the front substrate 20. Phosphor layers 19 are formed within first discharge spaces 18, and they are able to absorb ultraviolet rays and radiate visible light. The first discharge spaces 18 are filled with a discharge gas (for example a gas mixture including xenon (Xe), neon (Ne), etc.).

Barrier ribs 16 partitioning a plurality of first discharge spaces 18 are formed on the surface of the rear substrate 10 facing the front substrate 20. Although the barrier ribs 16 are formed on the rear substrate 10 in the present embodiment, the barrier ribs 16 may be formed by etching the rear substrate 10 into the shape corresponding to the first discharge spaces 18. In this embodiment, the barrier ribs 16 and the rear substrate 10 are made from the same material.

The barrier ribs 16 include first barrier rib members 16a and second barrier rib members 16b. The first barrier rib members 16a extend along a first direction (y-axis direction in the drawings), and the second barrier rib members 16b extend along a second direction (x-axis direction in the drawings) intersecting the first direction. The first discharge spaces 18 are partitioned by the first barrier rib members 16a and the second barrier rib members 16b. However, the structure of the barrier ribs is not limited to the above-described structure. A stripe-type barrier rib structure including barrier rib members parallel only to the first direction may be applied to the present embodiments, and barrier rib structures of various shapes (e.g. rectangle, triangle, circular, oval, etc.) partitioning a second discharge space are possible and are within the scope of the present embodiments.

First electrodes (hereinafter referred to as address electrodes) 22 extend along the first direction on the surface of the front substrate 20 facing the rear substrate 10. The address electrodes 22 are arranged parallel to and spaced apart from each other. A front dielectric layer 24 is formed on the front substrate 20 and covers the address electrodes 22. Second electrodes (hereinafter referred to as sustain electrodes) 25 and third electrodes (hereinafter referred to as scan electrodes) 26 are formed on the front dielectric layer 24 and extend along the second direction.

An electrode dielectric layer 30 is formed on the front dielectric layer 24 and covers the sustain electrodes 25 and the scan electrodes 26. The electrode dielectric layer 30 includes a first dielectric member 27, a second dielectric member 28, and a third dielectric member 29. The first dielectric member 27, the second dielectric member 28, and the third dielectric member 29 extend respectively along the first direction and the second direction intersecting the first direction, thus forming second discharge spaces 21 on the front substrate 20.

The first discharge spaces 18 are partitioned by the first barrier rib members 16a and the second barrier rib members 16b, and the second discharge spaces 21 are partitioned on the front substrate 20. The first and second discharge spaces 18 and 21 are formed in shapes corresponding to each other and substantially define each discharge cell 17.

A protective layer 32 may be formed on the outer surface of the front dielectric layer 21 and the electrode dielectric layer 30. The protective layer 32 may be formed on the outer surface of the front dielectric layer 24 and the electrode dielectric layer 30 that are exposed to gas discharge. An example of the protective layer 32 may be a MgO protective layer 32. The protective layer 32 protects dielectric layers against collision with ions that are dissociated during the gas discharge. The protective layer 32 may improve the efficiency of discharge due to a high secondary electron emission factor when colliding with the ions.

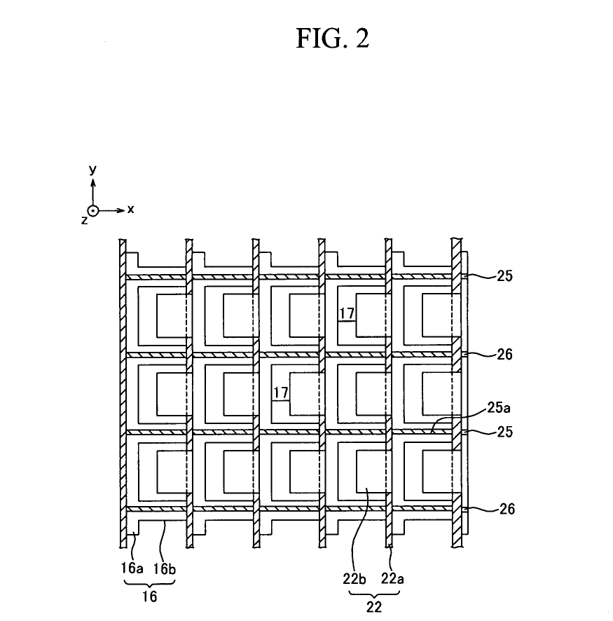

The phosphor layers 19 are formed within the discharge cells 17 (see FIG. 2). More specifically, the phosphor layers 19 are formed within the first discharge space 18 formed on the rear substrate 10, and the phosphor layers 19 may be made of a reflective phosphor. As described above, the present embodiment have the advantage of having an even discharge firing voltage within each discharge cell 17 during address discharge with the address electrodes 22 formed on the front substrate 20 and the phosphor layers 19 formed on the rear substrate 10.

The phosphor layers are located between the address electrodes and the scan electrodes for enabling address discharge in the conventional three-electrode surface discharge PDP, and there has been a drawback of uneven discharge firing voltage due to different permittivities between red, green, and blue phosphor layers. In the present embodiment, however, the address electrodes 22 and the scan electrodes 26 that enable address discharge are arranged on the front substrate 20 and the phosphor layer 19 is formed on the rear substrate 10, thus preventing uneven discharge firing voltage.

Because the address discharge occurs at the address electrodes 22 on the front substrate 20 and the scan electrodes 26 on the rear substrate 10, electrical charges do not accumulate on the phosphor layer 19 on the rear substrate during address discharge. Therefore, the durability loss of phosphor by ion sputtering of the accumulated charges on the phosphor layer 19 may be prevented.

Referring to FIG. 2, the address electrodes 22 extend along a first direction (y-axis direction in the drawings) and include bus electrodes 22a and protrusion electrodes 22b. The bus electrodes 22a correspond to the first barrier rib members 16a and extend along the first direction. The protrusion electrodes 22b correspond to each discharge cell 17 and protrude from the bus electrodes 22a toward the center of each discharge cell 17.

In this case, the protrusion electrodes 22b may be made of a transparent electrode material, for example ITO (indium tin oxide), for ensuring an adequate aperture ratio for the front substrate 20. Although the protrusion electrodes are in the shape of a rectangle in the present embodiment, protrusion electrodes of other shapes may also be applied to the present embodiment. For example, protrusion electrodes in a triangular shape gradually decreasing in size along a direction from the scan electrodes 26 toward the sustain electrodes 25 may be applied to the present embodiment and belong to the scope of the present embodiments. In addition, address discharge may occur easily with the protrusion electrodes 22b being closer to the scan electrodes 26 than to the sustain electrodes 25.

The bus electrodes 22a may be made of a metal so as to ensure high conductivity by compensating for high electrical resistance of the transparent electrodes. In the present embodiment, the bus electrodes 22a are located on the boundary of the discharge cells 17 adjacent to each other along the second direction (x-axis direction in the drawings). Thus, the present embodiment has the advantage that the aperture ratio for the front substrate 20 does not decrease, even though the bus electrodes 22a are made of metal.

The sustain electrodes 25 and the scan electrodes 26 are formed along a direction intersecting the address electrodes 22. In the present embodiment, the address electrodes 25 and the scan electrodes 26 are located on the boundary of discharge cells 17 adjacent to each other along the first direction (y-axis direction in the drawings), and are arranged alternately along the first direction. The scan electrodes 26 enable address discharge by interacting with the address electrodes 22 during an addressing period. The discharge cells 17 to be turned on are selected by the address discharge. The sustain electrodes 25 enable sustain discharge by interacting mainly with the scan electrodes 26. Images are displayed through the front substrate 20 by the sustain discharge. However, the role of each electrode varies with the kind of voltage supplied to the electrode and is not limited to the above.

The sustain electrodes 25 and the scan electrodes 26 can also be formed of metal. In other words, in the present embodiment, the sustain electrodes 25 and the scan electrodes 26 are located on the boundaries of discharge cells adjacent to each other along the first direction, so that the aperture ratio does not decrease, even if the electrodes are made of metal.

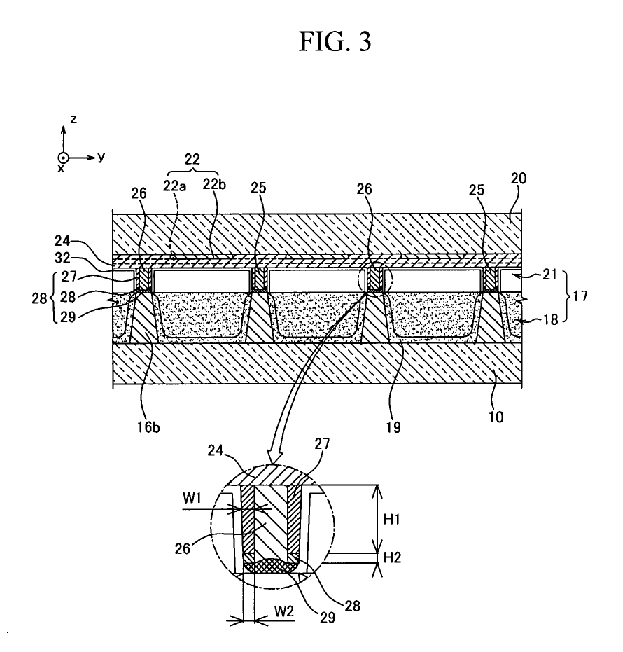

Referring to FIG. 3, the sustain electrodes 25 and the scan electrodes 26 are formed on the front dielectric layer 24 covering the address electrodes 22. The sustain electrodes 25 and the scan electrodes 26 protrude along a direction away from the front substrate 20, and face each other with a space therebetween. The cross-sections of the sustain electrodes 25 and the scan electrodes may be formed to have a length along a direction perpendicular to the substrates 10 and 20 (z-axis direction) longer than a length along a direction parallel to the substrates 10 and 20 (y-axis direction). The heights of the sustain electrodes 25 and the scan electrodes 26 measured from the surface of the front substrate 20 may be greater than their widths in the y-axis direction. By heightening the sustain electrodes 25 and the scan electrodes 25, even if the size of the discharge cell along a planar direction is to be diminished, the decrement of size can be compensated for. Furthermore, by enlarging the surface of the sustain electrodes 25 and the scan electrodes 26 facing each other, the efficiency of luminescence may be higher than that of the surface discharge PDP.

The electrode dielectric layer 30 (see FIG. 1) is formed on the outer surface of the sustain electrodes 25 and the scan electrodes 26. The electrode dielectric layer 30 and the front dielectric layer 24 covering the address electrodes 22 may be made of the same material, thus protecting each electrode against collision with electrical charges generated during a gas discharge. Wall charges may accumulate on the front dielectric layer 24 and the electrode dielectric layer 30, thus lowering the discharge firing voltage during a sustain discharge between the sustain electrodes 25 and the scan electrodes 26.

The electrode dielectric layer 30 includes the first dielectric member 27, the second dielectric member 28, and the third dielectric member 29. After the first dielectric member 27 is formed on the front dielectric layer 24, the second and third dielectric members 28 and 29 can be sequentially stacked thereon. More specifically, the first dielectric member 27 and the second dielectric member 28 are stacked in this order on the surface of the sustain electrodes 25 and the scan electrodes 26 facing each other, and the third dielectric member 29 is formed on the second dielectric member 28 and covers the surface of the sustain electrodes 25 and the scan electrodes 26 facing the rear substrate 10.

In this embodiment, the second dielectric member 28 has permittivity that is lower than that of the first dielectric member 27, and the opposed discharge occurring between the sustain electrodes 25 and the scan electrodes 26 can be stabilized by this structure.

The sustain electrodes 25 and the scan electrodes 26 with a structure of opposed discharge are formed on the front substrate 20 through drying and firing after a dielectric layer having grooves for forming electrodes is formed on the front substrate 20 and the grooves are filled with a paste for electrodes. In this embodiment, the dielectric layer is formed to be relatively thin around the edges of the surface of the sustain electrodes 25 and the scan electrodes 26 facing the rear substrate 10. Therefore, a discharge occurs first in the area where the dielectric layer is formed to be thin during a sustain discharge between the sustain electrodes 25 and the scan electrodes 26, and then the discharge spreads toward the area where the dielectric layer is formed to be relatively thick. In this case, the discharge occurs fiercely in the area where the dielectric layer is thin, such that there is a possibility that damage to the protective layer (e.g. MgO) covering the dielectric layer may be aggravated and that the ignition of sparks may lead to the degradation of the PDP.

In the present embodiment, however, the first dielectric member 27 and the second dielectric member 28 are formed on the surface of the sustain electrodes 25 and the scan electrodes 26 facing each other, and the second dielectric member 28 has permittivity lower than that of the first dielectric member 27, thus the second dielectric member 28 with the lower permittivity is located in the area where the dielectric layer is formed to be relatively thinner.

Although a width (W2) of the second dielectric member 28 is formed to be thinner than a width (W1) of the first dielectric member 27 measured along the first direction, permittivity of the second dielectric member 28 is lower than permittivity of the first dielectric member 27, and because the discharge firing voltage is inversely proportional to permittivity, from the beginning of discharge the opposed discharge occurs all over the surface between the sustain electrodes 25 and the scan electrodes 26 facing each other. Generally, the permittivity of the first dielectric member 27 located on the surface of the sustain electrodes 25 and the scan electrodes 26 has a value from about 10 F/m to about 20 F/m. Therefore, the permittivity of the second dielectric member may be lower than the values from about 10 F/m to about 20 F/m.

By forming the permittivity of the first dielectric member 27 and the second dielectric member 28 to be different, the discharge occurs all over the surface of the sustain electrodes 25 and the scan electrodes 26 facing each other from the beginning of the opposed discharge between the sustain electrodes 25 and the scan electrodes 26, thus the stability of the discharge is improved and the error rate of the PDP is reduced.

The third dielectric member 29 may also be made of materials with a permittivity higher than that of the first dielectric member 27 covering the surface of the sustain electrodes 25 or the scan electrodes 26 facing the rear substrate 10. The third dielectric member 29 may be substituted with the second dielectric member 28, and this also belongs to the scope of the present embodiments.

A length (H2) of the second dielectric member 28 measured along a direction perpendicular to the front substrate 20 (z-axis direction in the drawings) is formed to be shorter than a length (H1) of the first dielectric member 27. That is, on the surfaces of the sustain electrodes 25 and the scan electrodes 26, a discharge may occur first in the edge area close to the rear substrate 10, and then if the length (H2) of the second dielectric member 28 is longer than the length (H1) of the first dielectric member 27, the second dielectric member 28 may exert an influence on the area close to the front substrate 20 as well as on the edge area of the sustain electrodes 25 or the scan electrode 26. In this case, the stability of a discharge may be deteriorated because the permittivity of the second dielectric member 28 is lower than the permittivity of the first dielectric member 27. Therefore, by forming the length (H2) of the second layer 28 to be shorter than the length (H1) of the first dielectric member 27, the opposed discharge between the sustain electrodes 25 and the scan electrodes 26 may become stabilized.

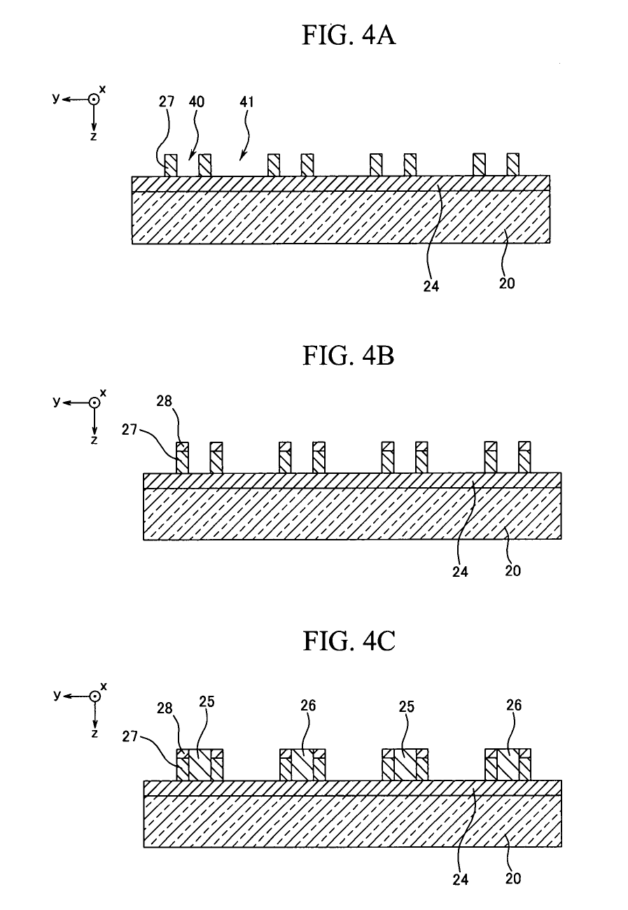

Referring to FIG. 4A, the first dielectric member 27 is formed on the front dielectric layer 24. Specifically, the first dielectric member 27 having grooves 40 for electrodes and grooves 41 for discharge spaces is formed on the front dielectric layer 24. The grooves 40 for electrodes and grooves 41 for discharge spaces may be formed by patterning the first dielectric member on the front dielectric layer 24 or etching the first dielectric member 27 by a mechanical or chemical method.

Referring to FIG. 4B, the second dielectric member 28 having permittivity lower than that of the first dielectric member 27 is formed on the first dielectric member 27. The second dielectric member 28 may be formed on the first dielectric member 27 by various methods, including patterning for example.

Referring to FIG. 4C, the sustain electrodes 25 and the scan electrodes 26 can be formed by patterning a paste, for example a Ag paste, into the grooves for electrodes formed by the first dielectric member 27 and the second dielectric member 28.

Referring to FIG. 4D, the third dielectric member 29 is formed on the second dielectric member 28, covering the sustain electrodes 25 and the scan electrodes 26. As above, the third dielectric member 29 is formed to at least cover the sustain electrodes 25 and the scan electrodes 26, thus preventing the sustain electrodes and the scan electrodes from being exposed.

The following are descriptions of various embodiments. The plasma display panel according to each embodiment has the same overall structure and function as that of the first embodiment, so a detailed description thereof is omitted.

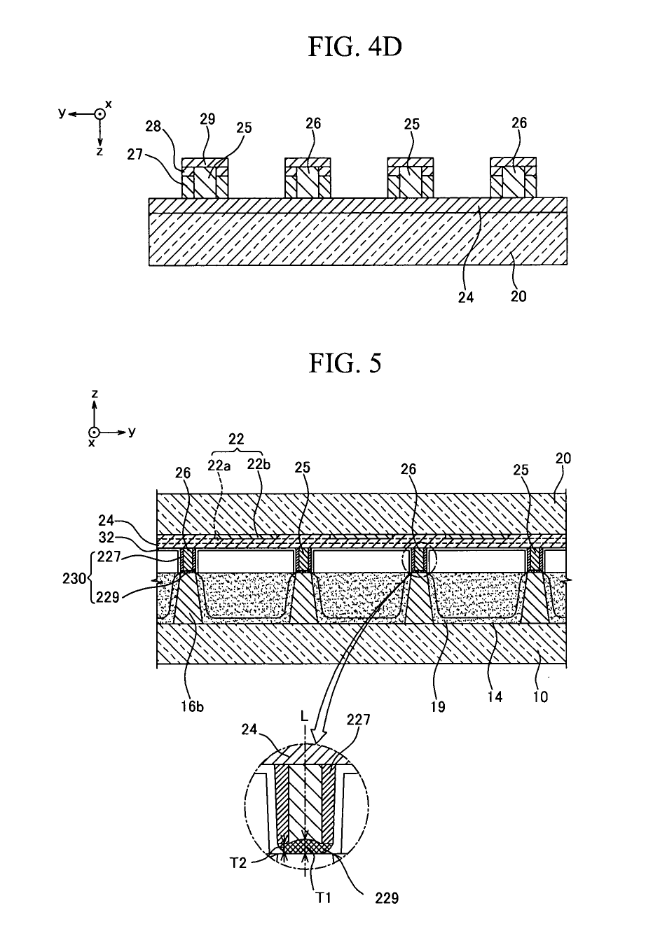

Referring to FIG. 5, an electrode dielectric layer 230 includes a first dielectric member 227 and a fourth dielectric member 229. The first dielectric member 227 is formed on the surface of the sustain electrodes 25 and the scan electrodes 26 facing each other. The fourth dielectric member 229 covers the surface of the sustain electrodes 25 and the scan electrodes 26 facing the rear substrate 10, and is formed on the first dielectric member 227.

In this embodiment, the electrode dielectric layer 230 formed on the sustain electrodes 25 and the scan electrodes 26 is formed be single-layered; the first dielectric member 227 and the fourth dielectric member 229 having permittivity lower than that of the first dielectric member 227 is formed on the first dielectric member 227.

As described above, after electrodes with a structure of opposed discharge are formed through a drying and firing process, the electrode dielectric layer 230 is formed to be thin around the edge area of the surface of the sustain electrodes 25 and the scan electrodes 26 facing the rear substrate 10. A thickness of the fourth dielectric member 229 measured along a direction perpendicular to the front substrate 20 (z-axis in the drawings) becomes thinner and thinner along a direction from the center area of the fourth dielectric member 229 toward the edge area.

When it is assumed that the axis of symmetry of the sustain electrodes 25 or the scan electrodes 26 is L, a thickness (T2) of the fourth dielectric member 229 formed around the edge area of the sustain electrodes 25 and the scan electrodes 26 is formed to be thinner than a thickness (T1) of the fourth dielectric member 229 measured from the axis of symmetry along a direction perpendicular to the front substrate 20. As above, the width of the fourth dielectric member 229 is formed to be thin, and during the opposed discharge between the sustain electrodes 25 and the scan electrodes 26 the discharge may occur unevenly.

In the present embodiment, however, the permittivity of the fourth dielectric member 229 is formed to be lower than the permittivity of the first dielectric member 227, thus having the opposed discharge between the sustain electrodes 25 and the scan electrodes 26 occur evenly and improving the stability of discharge.

The first dielectric member 227 may also be formed of a plurality of dielectric members. In this case, the plurality of dielectric members is stacked in descending order of permittivity along a direction away from the front substrate 20, thus improving the stability of discharge during the opposed discharge.

As described above, with the present embodiments, the sustain electrodes and the scan electrodes protrude along a direction away from the substrate, the discharge between the sustain electrodes and the scan electrodes may lead to opposed discharge, and the efficiency of luminescence and the brightness is further improved.

In addition, by making the dielectric layer formed on the outer surface of the sustain electrodes and the scan electrodes multi-layered and to have different permittivities, during the opposed discharge between the sustain electrodes and the scan electrodes the discharge occurs all over the opposing surfaces of the sustain electrodes and the scan electrodes, and the stability of discharge is improved. By preventing a discharge that may occur around the area where the dielectric layer is formed to be thin due to the differences in width of the dielectric layer, the protective layer (e.g. MgO) may be protected and sparks may be prevented such that the error rate of a PDP may be lowered.

Although certain exemplary embodiments have been shown and described, the present embodiments are not limited to the described embodiments, but may be modified in various forms without departing from the scope of the present embodiments set forth in the detailed description, the accompanying drawings, the appended claims, and their equivalents.

What is claimed is:

1. A plasma display panel comprising:
a first substrate;
a second substrate facing the first substrate;
discharge cells defined in a space between the first substrate and the second substrate;
first electrodes formed between the first substrate and the second substrate and extending along a first direction;
second electrodes formed apart from the first electrodes on the second substrate and extending along a second direction perpendicular to the first direction, wherein the second electrodes protrude from the second substrate;
third electrodes formed apart from the first electrodes on the second substrate and extending along the second direction, wherein the third electrodes protrude from the second substrate and face the second electrodes; and
a dielectric layer formed on the outer surface of the second electrodes and the third electrodes,
wherein the dielectric layer includes
a first dielectric member formed on the surfaces of the second electrodes and the third electrodes facing each other, and
a second dielectric member formed on the first dielectric member and having a smaller permittivity than that of the first dielectric member.

2. The plasma display panel of claim 1, further comprising barrier ribs partitioning the discharge cells and formed adjacent to the first substrate,
wherein the barrier ribs include:
first barrier rib members extending along the first direction; and
second barrier rib members extending along the second direction.

3. The plasma display panel of claim 1, wherein the first electrodes are formed on the second substrate and are located on the boundary of discharge cells adjacent to each other along the second direction.

4. The plasma display panel of claim 3, wherein the first electrodes include transparent electrodes protruding into the center of respective discharge cells, and wherein the transparent electrodes are formed closer to the third electrodes than to the second electrodes.

5. The plasma display panel of claim 4 wherein the transparent electrodes comprise indium tin oxide.

6. The plasma display panel of claim 1, wherein the second electrodes and the third electrodes are located on the boundary of discharge cells adjacent to each other along the first direction, and arranged alternately along the first direction.

7. The plasma display panel of claim 1, wherein the second dielectric member is formed on the surfaces of the second electrodes and the third electrodes facing each other.

8. The plasma display panel of claim 7, wherein the width of the second dielectric member measured along the first direction is smaller than the width of the first dielectric member.

9. The plasma display panel of claim 7, further comprising a third dielectric member covering the surfaces of the second electrodes and the third electrodes facing the first substrate, and formed on the second dielectric member.

10. The plasma display panel of claim 1, wherein the second dielectric member is located closer to the surfaces of the second electrodes or the third electrodes facing the first substrate than the first dielectric member.

11. The plasma display panel of claim 1, wherein the length of the second dielectric member measured along a direction perpendicular to the second substrate is smaller than the length of the first dielectric member.

12. A plasma display panel comprising:
a first substrate;
a second substrate facing the first substrate;
discharge cells defined in a space between the first substrate and the second substrate;
first electrodes formed between the first substrate and the second substrate and extending along a first direction;
second electrodes formed apart from the first electrodes on the second substrate and extending along a second direction perpendicular to the first direction, wherein the second electrodes protrude from the second substrate;
third electrodes formed apart from the first electrodes on the second substrate and extending along the second direction, wherein the third electrodes protrude from the second substrate and face the second electrodes; and
a dielectric layer formed on the outer surface of the second electrodes and the third electrodes,
wherein the dielectric layer includes
a first dielectric member formed on the surfaces of the second electrodes and the third electrodes facing each other, and
a fourth dielectric member covering the surfaces of the second electrodes or the third electrodes facing the first substrate, and having smaller permittivity than that of the first dielectric member.

13. The plasma display panel of claim 12, wherein
the second electrodes and the third electrodes are located on the boundary of discharge cells adjacent to each other along the first direction, and are arranged alternately along the first direction.

14. The plasma display panel of claim 13, wherein the width of the fourth dielectric member measured along a direction perpendicular to the second substrate becomes smaller along a direction from the center of surfaces of the second electrodes or the third electrodes facing the first substrate to edges thereof.

15. The plasma display panel of claim 12, wherein the first dielectric member comprises a plurality of stacked dielectric members having different permittivities.

16. The plasma display panel of claim 15, wherein the plurality of dielectric members are stacked in a descending order of permittivity along a direction away from the second substrate.
